(19) United States
(12) Patent Application Publication
(10) Pub. No.: US 2019/0217512 A1
(43) Pub. Date: Jul. 18, 2019

(54) MANUFACTURING METHOD OF ASSEMBLY INJECTION MOLDED ARTICLE, AND ASSEMBLY INJECTION MOLDED ARTICLE USING THE SAME

(71) Applicants: Guangzhou Lite-on Mobile Electronic Components Co., Guangzhou (CN); LITE-ON TECHNOLOGY CORPORATION, Taipei City (TW)

(72) Inventors: KY Huang, Taichung City (TW); Kenny Peng, Shenzhen (CN)

(21) Appl. No.: 16/026,748

(22) Filed: Jul. 3, 2018

(30) Foreign Application Priority Data
Jan. 12, 2018 (CN) 201810033423.1

(51) Int. Cl. B29C 45/14

(52) U.S. Cl. CPC B29C 45/14065; B29C 45/14377; B29K 2705/00; B29C 2045/14131; B29C 45/14639

(57) ABSTRACT

A manufacturing method of an assembly injection molded article includes: preparing a first injection molded member; inserting insertion members into insertion holes of the first injection molded member to form an intermediate assembly; placing the intermediate assembly on a mold core of an injection molding mold, in which the mold core has in-mold insertion holes, and the insertion members are inserted into the in-mold insertion holes; and forming a second injection molded member on a side of the first injection molded member opposite to the mold core through the injection molding mold such that the first injection molded member, the insertion members, and the second injection molded member are assembled together. The present disclosure also provides an assembly injection molded article. The advantage of the present disclosure is to avoid burrs formed at seams between the insertion members and an appearance surface of the assembly injection molded article.

### BACKGROUND OF THE INVENTION

### 1. Field of the Invention

The present disclosure relates to a manufacturing method of an assembly injection molded article, and an assembly injection molded article using the same, and in particular, to a manufacturing method of an assembly injection molded article, and an assembly injection molded article using the same suitable for use in the manufacture of an in-mold insert plastic injection molded article.

### 2. Description of Related Art

Electronic components and hardware products, such as plugs, cable connectors, electronic housings, and screwdrivers, are often manufactured by using an assembly of a metal insertion member and a plastic body. Conventional manufacturing methods adopt an insert molding process to manufacture these types of electronic components and hardware products in order to achieve the purpose of simplifying the assembly procedure, enhancing the aesthetic appearance of the product, and enhancing the bonding strength between the metal insertion member and the plastic body.

The conventional insert molding process typically includes the steps of: inserting the insertion member into an injection molding mold; injecting an molten plastic material into the injection molding mold to bond the plastic material and the insertion member; and performing a de-molding step after the plastic material is cooled and molded so as to obtain an assembly injection molded article that combines the insertion member and the plastic body.

In the conventional insert molding process, the injection molding mold generally has an in-mold insertion hole or a positioning groove capable of accommodating the insertion member so as to enable the insertion member to be positioned in a mold cavity of the injection molding mold. Generally, there is usually a gap between the insertion member and the in-mold insertion hole or the positioning groove. Further, when the molten plastic material is injected into the mold cavity, the high-pressure and molten plastic material may penetrate into the gap between the insertion member and the in-mold insertion hole or the positioning groove. Therefore, a burr may be formed at a seam between the insertion member and the plastic material of the injection molded article. Moreover, if the burr is formed on an appearance surface of the injection molded article and the size of the burr is too large, the appearance of the injection molded article will be unfavorable.

In the conventional insert molding process, the method commonly used to overcome the formation of the burr at the seam of the insertion member is improving the machining accuracy of the in-mold insertion hole or the positioning groove capable of positioning the insertion member, so as to minimize the gap between the insertion member and the in-mold insertion hole or the positioning groove. Accordingly, the size of the burr formed at the seam between the insertion member and the injection molded article may be reduced or become insignificant.

The gap between the insertion member and the in-mold insertion hole needs to be precisely controlled, and the size of the gap generally needs to be less than 0.03 mm. If the gap is too large, the burr may be formed. On the contrary, if the gap is too small, the insertion member may be scratched during plugging and unplugging. However, the manufacture of the insertion members generally has tolerances, and has the problems of thermal expansion and deformation, resulting in a variance of the gap between the insertion member and the in-mold insertion hole. Therefore, the problems of the burr formed on the appearance surface of the injection molded article, and the scratch formed on the insertion member are difficult to overcome.

In this regard, the present disclosure provides a manufacturing method of an assembly injection molded article, and an assembly injection molded article using the same to overcome the aforementioned drawbacks.

### SUMMARY OF THE INVENTION

The main object of the present disclosure is to solve the drawbacks associated with the prior art.

The present disclosure provides a manufacturing method of an assembly injection molded article including: preparing a first injection molded member; in which the first injection molded member has a first surface and a second surface opposite to the first surface, and the first injection molded member is formed with a plurality of insertion holes respectively penetrating from the first surface to the second surface; preparing a plurality of insertion members; in which two ends of each of the insertion members along a center axis direction are respectively defined as a first end and a second end; inserting the insertion members into the insertion holes such that the insertion members and the first injection molded member are assembled into an intermediate assembly; in which cross-sectional shapes of portions of the insertion members coupled to the insertion holes correspond to shapes of the insertion holes, the first ends of the insertion members are protruded from the first surface of the first injection molded member, and the second ends of the insertion members are protruded from the second surface of the first injection molded member; placing the intermediate assembly on a mold core of an injection molding mold; in which the mold core is formed with a plurality of in-mold insertion holes corresponding to the insertion members; in which when the intermediate assembly is placed on the mold core, the second surface of the first injection molded member abuts on the mold core, and the second ends of the insertion members are respectively inserted into the in-mold insertion holes; and forming a second injection molded member on a portion of the intermediate assembly exposed outside of the mold core such that the first surface of the first injection molded member and the first ends of the insertion members are covered by the second injection molded member.

In one preferred embodiment of the present disclosure, the second surface of the first injection molded member is an appearance surface, and when the assembly injection molded article is molded, the second surface is exposed to an outer surface of the assembly injection molded article.

In one preferred embodiment of the present disclosure, a single sided gap between each of the insertion members on the first injection molded member and the corresponding insertion hole is arranged to be less than 0.03 mm, and a single sided gap between each of the insertion members and the corresponding in-mold insertion hole is arranged between 0.03 mm and 0.2 mm.

In one preferred embodiment of the present disclosure, the single sided gap between each of the insertion members on the first injection molded member and the corresponding insertion hole is arranged between 0.005 mm and 0.025 mm.

In one preferred embodiment of the present disclosure, in each of the insertion members, the first end of the insertion member is provided with a protruding portion, and the protruding portion is extended from a surface of the first end of the insertion member toward a direction away from the surface of the insertion member.

In one preferred embodiment of the present disclosure, a side of the protruding portion close to the first injection molded member has a bottom face, the bottom face forms a gap with the first surface of the first injection molded member such that the bottom face of the protruding portion is covered by the second injection molded member when the second injection molded member is formed.

The present disclosure also provides an assembly injection molded article including: a first injection molded member having a first surface and a second surface opposite to the first surface, and the first injection molded member being formed with a plurality of insertion holes respectively penetrating from the first surface to the second surface; a plurality of insertion members; in which two ends of each of the insertion members along a center axis direction are respectively defined as a first end and a second end, the insertion members are respectively inserted into the insertion holes, cross-sectional shapes of portions of the insertion members coupled to the insertion holes correspond to shapes of the insertion holes, the first ends of the insertion members are protruded from the first surface of the first injection molded member, and the second ends of the insertion members are protruded from the second surface of the first injection molded member; and a second injection molded member formed on the first injection molded member, and the second injection molded member having a bottom face; in which when the second injection molded member is formed, the bottom face of the second injection molded member is coupled to the first surface of the first injection molded member, and the first ends of the insertion members pass through the bottom face of the second injection molded member and are covered by the second injection molded member.

The advantageous effects of the present disclosure are to effectively avoid the burr formed at the seams between the insertion members and the appearance surface of the assembly injection molded article, and enlarge the single sided gap between each of the insertion members and the corresponding in-mold insertion hole of the injection molding mold so as to prevent the insertion members from being scratched during plugging and unplugging, and reduce the manufacturing cost of the injection molding mold and the deformation of the assembly injection molded article.

For further understanding of the present disclosure, the following embodiments are provided to facilitate the disclosure of the present disclosure.

### BRIEF DESCRIPTION OF THE DRAWINGS

FIG. 1 is a perspective view showing an assembly injection molded article according to an embodiment of the present disclosure;

FIG. 2 is an exploded view of FIG. 1;

FIGS. 3 to 5 are schematic views showing a manufacturing method of the assembly injection molded article according to the embodiment of the present disclosure;

FIG. 6A is a cross-sectional view showing a process of the manufacturing method of the assembly injection molded article according to the embodiment of the present disclosure;

FIG. 6B is a partial enlarged view from a part of a region VIB of FIG. 6A;

FIG. 7 is an exploded view showing the assembly injection molded article adopting insertion members with a rectangular cross-sectional shape according to another embodiment of the present disclosure; and

FIG. 8 is a schematic view showing a process of the manufacturing method of the assembly injection molded article adopting the insertion members with the rectangular cross-sectional shape according to another embodiment of the present disclosure.

### DETAILED DESCRIPTION OF PREFERRED EMBODIMENTS

The afore-mentioned illustrations and following detailed descriptions are exemplary for the purpose of further explaining the scope of the instant disclosure. Other objectives and advantages related to the instant disclosure will be illustrated in the subsequent descriptions and appended drawings. In addition, for an easy instruction, similar reference numbers or symbols refer to elements alike.

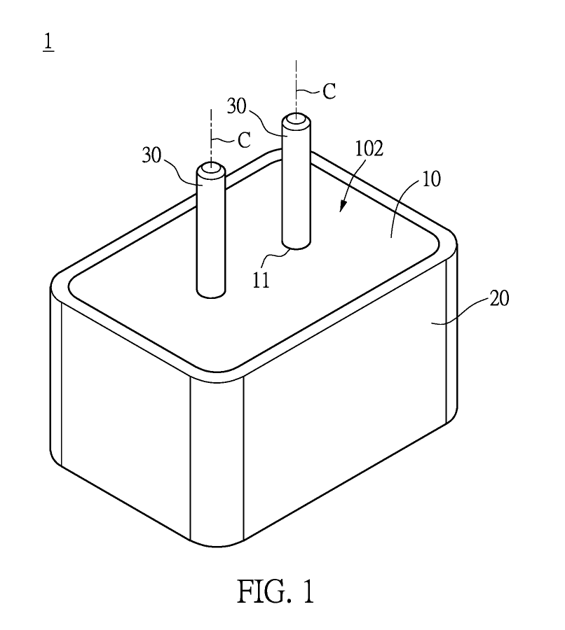

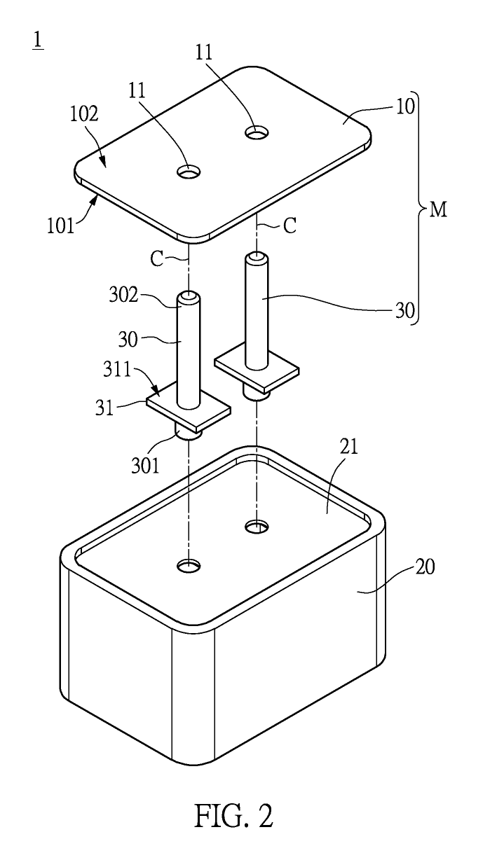

Referring to FIG. 1 to FIG. 6, the present embodiment discloses a manufacturing method of an assembly injection molded article, and an assembly injection molded article using the same. FIG. 1 and FIG. 2 show the assembly injection molded article 1 manufactured by the method of the present embodiment. The assembly injection molded article 1 can be a main body of a two-color injection molded plug. The assembly injection molded article 1 mainly includes a first injection molded member 10, a second injection molded member 20, and a plurality of insertion members 30.

Referring to FIG. 2, in the present embodiment, the first injection molded member 10 has a sheet-like structure made of a plastic material and formed by an injection molding process. The first injection molded member 10 has a first surface 101 and a second surface 102 opposite to the first surface 101, and the first injection molded member 10 is formed with a plurality of insertion holes 11 which are respectively penetrating from the first surface 101 to the second surface 102. Further, the first surface 101 of the first injection molded member 10 is a hidden surface, and the second surface 102 of the first injection molded member 10 is an appearance surface. That is, when the assembly injection molded article 1 is molded, the first surface 101 is covered and hidden by the second injection molded member 20, and the second surface 102 is exposed to an outer surface of the assembly injection molded article 1 that is externally visible.

The insertion members 30 may be made of a metal material or other non-plastic materials. In the present embodiment, the insertion members 30 are plug terminals made of the metal material, and cross-sectional shapes of the insertion members 30 correspond to shapes of the insertion holes 11 so as to enable the insertion members 30 to be respectively inserted into the insertion holes 11. Two ends of each of the insertion members 30 along a center axis direction C are respectively defined as a first end 301 and a second end 302. When the insertion members 30 are inserted into the insertion holes 11 of the first injection molded member 10, the insertion members 30 and the first injection molded member 10 are assembled into an intermediate assembly M. Moreover, the first ends 301 of the insertion members 30 are protruded from the first surface 101 of the first injection molded member 10, and the second ends 302 of the insertion members 30 are protruded from the second surface 102 of the first injection molded member 10.

The second injection molded member 20 is combined with the intermediate assembly M through the injection molding process so as to form an outer shell of a plug. The second injection molded member 20 and the first injection molded member 10 can be made of different colored plastic materials such that the assembly injection molded article 1 of the present embodiment can be formed as a two-color injection molded product. In more detail, the manufacturing method of the assembly injection molded article 1 includes: combining the first injection molded member 10 with the insertion members 30 before the second injection molded member 20 is formed so as to form the intermediate assembly M; putting the intermediate assembly M into an injection molding mold capable of forming the second injection molded member 20; injecting a plastic material into a mold cavity of the injection molding mold to enable the plastic material in the mold cavity to be formed as the second injection molded member 20 and to enable the second injection molded member 20 and the intermediate assembly M putted in the mold cavity to be combined with each other so as to form the assembly injection molded article 1.

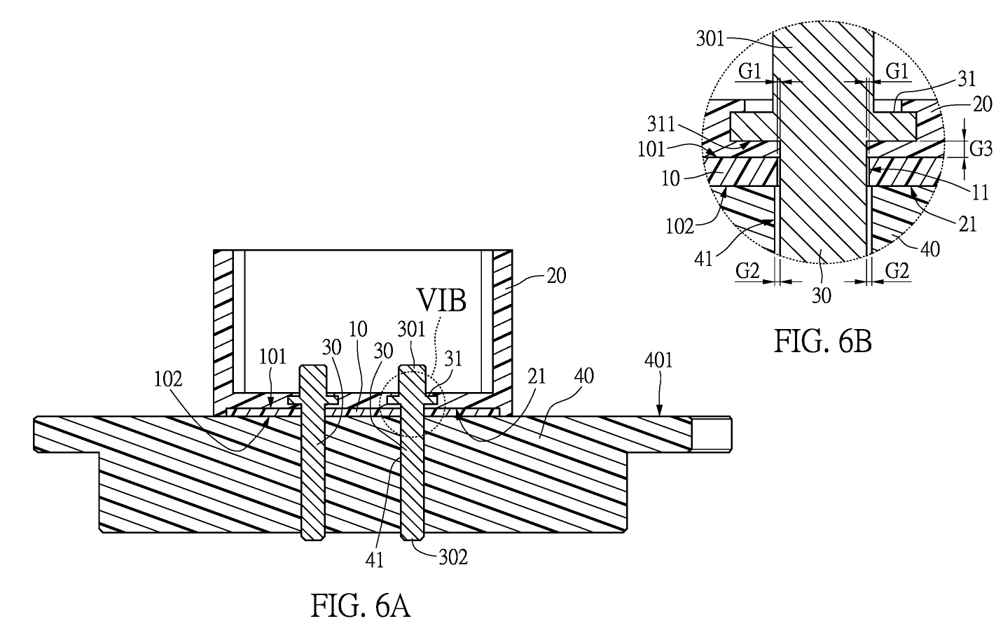

Referring to FIG. 6B, FIG. 6B is a partial enlarged sectional view showing a process of the manufacturing method of the assembly injection molded article 1 according to the present embodiment. More particularly, FIG. 6B discloses a structure in which each of the insertion members 30 of the intermediate assembly M is inserted into the corresponding in-mold insertion hole 41 of the mold core 40, and the second injection molded member 20 is formed and covered on the first injection molded member 10 and the insertion members 30. As shown in FIG. 6B, for the convenience of explanation, a single sided gap between each of the insertion members 30 and the corresponding insertion hole 11 of the first injection molded member 10 is denoted by reference numeral G1, and a single sided gap between each of the insertion members 30 and the corresponding in-mold insertion hole 41 of the mold core 40 is denoted by reference numeral G2. Moreover, in each of the insertion members 30, the first end 301 of the insertion member 30 is provided with a protruding portion 31 which has a bottom face 311, and a gap between the bottom face 311 of the protruding portion 31 and the first surface 101 of the first injection molded member 10 is denoted by reference numeral G3.

Specifically, the single sided gap G1 between each of the insertion members 30 on the first injection molded member 10 and the corresponding insertion hole 11 means that a distance between a side wall of the insertion member 30 and an inner wall of the insertion hole 11 when each of the insertion members 30 is inserted into the corresponding insertion hole 11 and is aligned with the center of the corresponding insertion hole 11. The single sided gap G2 between each of the insertion members 30 and the corresponding in-mold insertion hole 41 of the mold core 40 means that a distance between a side wall of the insertion member 30 and an inner wall of the in-mold insertion hole 41 when each of the insertion members 30 is inserted into the corresponding in-mold insertion hole 41 and is aligned with the center of the corresponding in-mold insertion hole 41.

Referring to FIG. 2, FIG. 6A, and FIG. 6B, to improve the bonding strength between the insertion members 30 and the second injection molded member 20, the first end 301 of each of the insertion members 30 is provided with a protruding portion 31, and the protruding portion 31 is extended from a surface of the first end 301 of the insertion member 30 toward a direction away from the surface of the insertion member 30 and is substantially perpendicular to a central axis of the insertion member 30. Referring to FIG. 6B, a side of each of the protruding portions 31 close to the first injection molded member 10 has a bottom face 311. When the insertion members 30 are inserted on the first injection molded member 10, the bottom face 311 of each of the protruding portions 31 forms a gap G3 with the first surface 101 of the first injection molded member 10 such that the bottom face 311 of each of the protruding portions 31 is covered by the second injection molded member 20 when the second injection molded member 20 is formed. Accordingly, the bonding strength between the first ends 301 of the insertion members 30 and the second injection molded member 20 can be greatly improved.

Referring to FIG. 6A and FIG. 6B, when the second injection molded member 20 is formed, a bottom face 21 of the second injection molded member 20 is coupled to the first surface 101 of the first injection molded member 10, and the first ends 301 of the insertion members 30 pass through the bottom face 21 of the second injection molded member 20 and are covered by the second injection molded member 20.

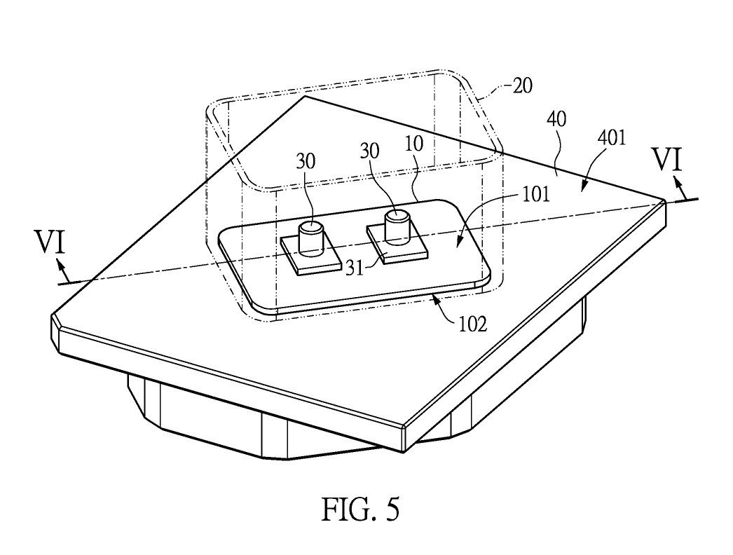

The structural feature of the assembly injection molded article 1 of the present embodiment is that since the first injection molded member 10 is formed before the insertion members 30 and the first injection molded member 10 are assembled into the intermediate assembly M, formation of a burr at the seam of the first injection molded member 10 and each of the insertion members 30 can be avoided. Meanwhile, referring to FIG. 5, FIG. 6A, and FIG. 6B, since the position where the second injection molded member 20 and the first injection molded member 10 are combined with each other is located on the first surface 101 of the first injection molded member 10, the molten plastic material configured to form the second injection molded member 20 only contacts the first surface 101 of the first injection molded member 10 when the injection molding process of the second injection molded member 20 is performed. Accordingly, even if the single sided gap G1 is existed between each of the insertion members 30 and the corresponding insertion hole 11 of the first injection molded member 10, the molten plastic material can only enter the single sided gap G1 from a side of the first surface 101 of the first injection molded member 10. Moreover, the single sided gap G1 between each of the insertion members 30 and the corresponding insertion hole 11 of the first injection molded member 10 is arranged to be less than 0.03 mm so that the single sided gap G1 between each of the insertion members 30 and the corresponding insertion hole 11 can be smaller than the gap size that the molten plastic material can flow smoothly. Accordingly, the molten plastic material in the single sided gap G1 cannot penetrate to the second surface 102 of the first injection molded member 10 so as to avoid the formation of the burr on an appearance surface of the first injection molded member 10.

In particular, the size of the single sided gap G1 is preferably arranged within a range between 0.005 mm and 0.025 mm. Specifically, the size of the single sided gap G1 is selected based on the viscosity or the density of the injection plastic material.

Therefore, the assembly injection molded article 1 of the present embodiment enables the burr formed between the second injection molded member 20 and each of the insertion members 30 to be confined in an end of the single sided gap G1 close to the first surface 101 such that the burr of the assembly injection molded article 1 is hidden in the seam of the first injection molded member 10 and the second injection molded member 20, and is not exposed on the appearance surface of the assembly injection molded article 1 so as to achieve the purpose of enhancing the aesthetic appearance of the product.

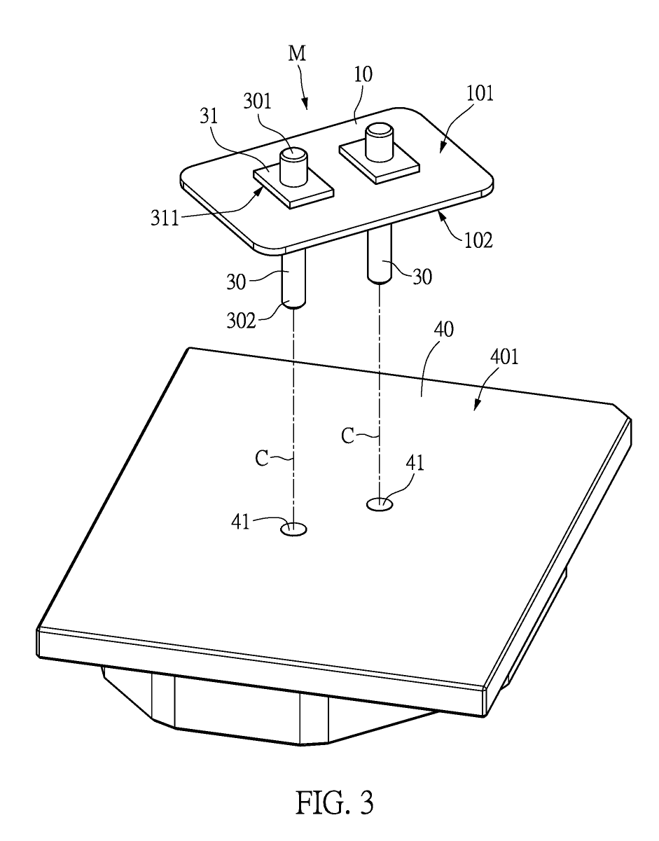

FIGS. 3 to 6B are schematic views showing the manufacturing method of the assembly injection molded article 1. Referring to FIG. 3, the manufacturing method of the assembly injection molded article 1 includes preparing the first injection molded member 10 through the injection molding process; inserting the insertion members 30 into the insertion holes 11 of the first injection molded member 10 after the first injection molded member 10 is formed such that the insertion members 30 and the first injection molded member 10 are assembled into the intermediate assembly M; and inserting the intermediate assembly M into the mold cavity of the injection molding mold capable of forming the second injection molded member 20.

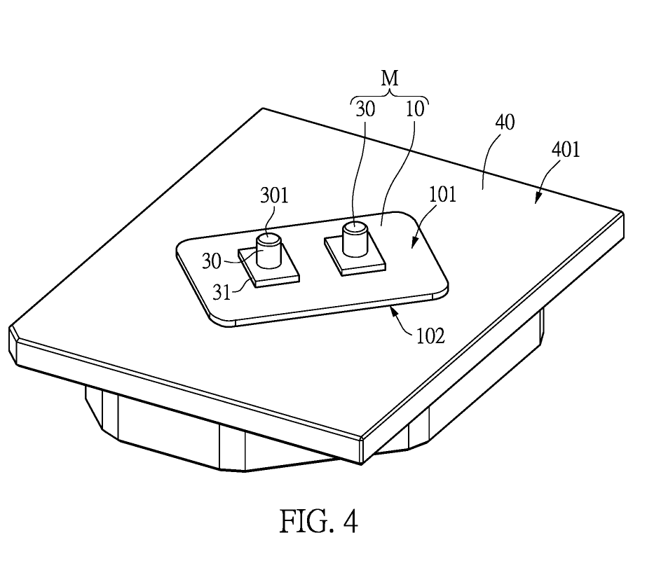

Referring to FIG. 3 and FIG. 4, the injection molding mold capable of forming the second injection molded member 20 includes a mold core 40, in which the mold core 40 is formed with a plurality of in-mold insertion holes 41, and positions of the in-mold insertion holes 41 correspond to positions of the insertion members 30. Moreover, shapes and sizes of the in-mold insertion holes 41 correspond to cross-sectional shapes of the insertion members 30 such that the insertion members 30 of the intermediate assembly M are capable of being inserted into the in-mold insertion holes 41 of the mold core 40.

Referring to FIG. 4, when the intermediate assembly M is disposed on the mold core 40, the second surface 102 of the first injection molded member 10 faces the mold core 40, and the second surface 102 abuts on a top face 401 of the mold core 40. Meanwhile, the second ends 302 of the insertion members 30 are respectively inserted into the in-mold insertion holes 41 such that the intermediate assembly M is positioned on the mold core 40.

Referring to FIG. 5 and FIG. 6A, the manufacturing method of the assembly injection molded article 1 further includes forming the second injection molded member 20 through the injection molding mold after the intermediate assembly M is positioned on the mold core 40. The injection molding mold has a mold cavity (not shown in the Figures) for forming the second injection molded member 20. When the second injection molded member 20 is formed in the mold cavity, the second injection molded member 20 can be combined with the first surface 101 of the first injection molded member 10 and the first ends 301 of the insertion members 30 so as to form the assembly injection molded article 1 of the present embodiment.

Referring to FIG. 6A and FIG. 6B, when the step of forming the second injection molded member 20 is performed, the first injection molded member 10 is located between the second injection molded member 20 and the mold core 40. Therefore, when the molten plastic material is injected into the mold cavity (not shown in the Figs) of the injection molding mold, the molten plastic material only contacts the first surface 101 of the first injection molded member 10. Moreover, since the single sided gap G1 between each of the insertion members 30 and the corresponding insertion hole 11 of the first injection molded member 10 is specially arranged, the molten plastic material cannot penetrate to the single sided gap G1 and cannot flow to the second surface 102 of the first injection molded member 10 through the single sided gap Gl. That is, the top face 401 of the mold core 40 is not in contact with the molten plastic material within the range covered by the first injection molded member 10.

According to the above configuration, the injection molding mold for forming the second injection molded member 20 of the present embodiment needs not to take into consideration the problem that the burr is formed by the molten plastic material that is penetrating into the single sided gap G2 between each of the insertion members 30 and the corresponding in-mold insertion hole 41 of the mold core 40. Therefore, the single sided gap G2 between each of the insertion members 30 and the corresponding in-mold insertion hole 41 of the mold core 40 can be arranged in a larger size such that the insertion members 30 are not easily scratched by the in-mold insertion holes 41, and the in-mold insertion holes 41 are easier to manufacture so as to improve the product yield and reduce the manufacturing cost of the injection molding mold. In other words, the single sided gap G2 between each of the insertion members 30 and the corresponding in-mold insertion hole 41 can be enlarged through the technical solution of the present embodiment. For example, as shown in FIG. 6B, the single sided gap G2 between each of the insertion members 30 and the corresponding in-mold insertion hole 41 of the mold core 40 can be arranged within the range between 0.03 mm and 0.2 mm. It should be noted that, the range is selected according to the factors such as the thickness and the forming pressure of the first injection molded member 10 such that the molten plastic material cannot easily penetrate to the single sided gap G1 between each of the insertion members 30 and the corresponding insertion hole 11, and the insertion members 30 are not easily scratched when being inserted into the in-mold insertion holes 41.

Another advantageous effect of the present embodiment is to reduce the deformation of the assembly injection molded article 1. Specifically, since the insertion members 30 of the present embodiment are inserted into the insertion holes 11 of the first injection molded member 10 and are positioned by the insertion holes 11, the insertion members 30 can be positioned not only by the in-mold insertion holes 41 but also by the insertion holes 11 when the step of forming the second injection molded member 20 is performed. Accordingly, the problem of the positioning accuracy of the insertion members 30 being affected by the flow and the pressure of the molten plastic material during the injection molding process (i.e. the insertion members 30 are inclined) can be avoided so as to reduce the deformation of the assembly injection molded article 1.

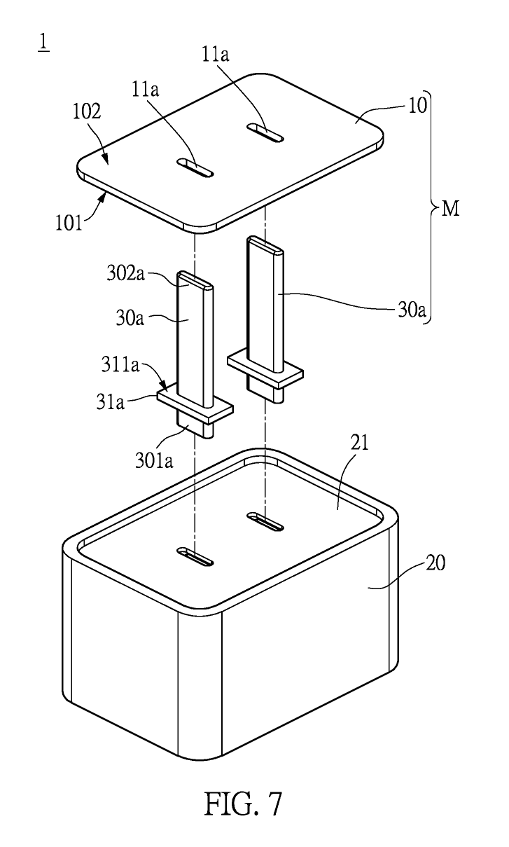

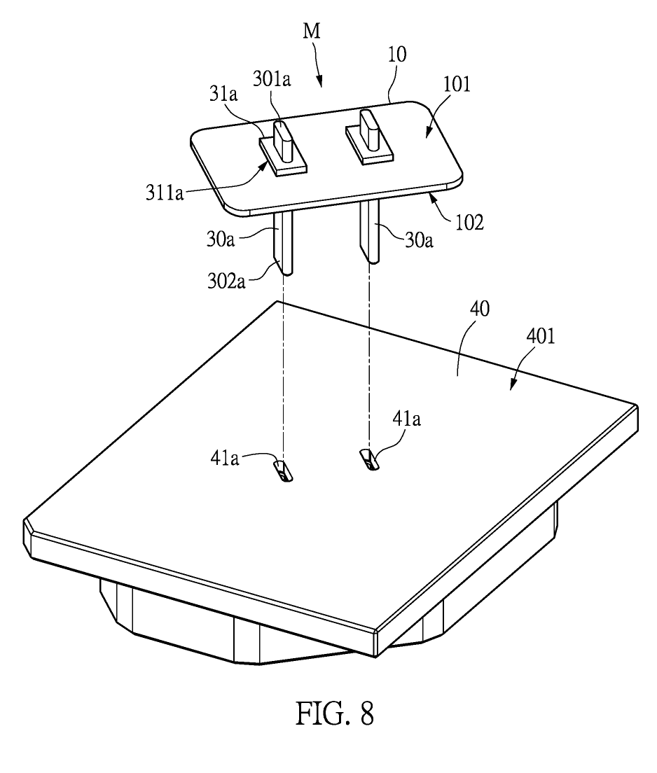

It is worth mentioning that the insertion members 30 shown in FIGS. 1 to 6B are the insertion members having a cylindrical cross-sectional shape. However, in practical applications, the cross-sectional shapes of the insertion members 30 can be various shapes, such as square, rectangular, polygonal and other geometric shapes, and are not limited to the drawings. For example, the insertion members 30a shown in FIG. 7 and FIG. 8 have a rectangular cross-sectional shape, and the insertion holes 11a of the first injection molded member 10 and the in-mold insertion holes 41a of the mold core 40 also correspond to the cross-sectional shape of the insertion members 30a.

### Advantageous Effects of the Present Embodiment

As described above, the advantageous effects of the present embodiment are to effectively avoid the burr formed at the seams between the insertion members 30 and the appearance surface of the assembly injection molded article 1, and enlarge the single sided gap G2 between each of the insertion members 30 and the corresponding in-mold insertion hole 41 of the injection molding mold so as to prevent the insertion members 30 from being scratched during plugging and unplugging, and reduce the manufacturing cost of the injection molding mold and the deformation of the assembly injection molded article 1.

The descriptions illustrated supra set fourth simply the preferred embodiment of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A manufacturing method of an assembly injection molded article, comprising:
preparing a first injection molded member; wherein the first injection molded member has a first surface and a second surface opposite to the first surface, and the first injection molded member is formed with a plurality of insertion holes respectively penetrating from the first surface to the second surface;
preparing a plurality of insertion members; wherein two ends of each of the insertion members along a center axis direction are respectively defined as a first end and a second end;
inserting the insertion members into the insertion holes such that the insertion members and the first injection molded member are assembled into an intermediate assembly; wherein cross-sectional shapes of portions of the insertion members coupled to the insertion holes correspond to shapes of the insertion holes, the first ends of the insertion members are protruded from the first surface of the first injection molded member, and the second ends of the insertion members are protruded from the second surface of the first injection molded member;
placing the intermediate assembly on a mold core of an injection molding mold; wherein the mold core is formed with a plurality of in-mold insertion holes corresponding to the insertion members; wherein when the intermediate assembly is placed on the mold core, the second surface of the first injection molded member abuts on the mold core, and the second ends of the insertion members are respectively inserted into the in-mold insertion holes; and
forming a second injection molded member on a portion of the intermediate assembly exposed outside of the mold core such that the first surface of the first injection molded member and the first ends of the insertion members are covered by the second injection molded member.

2. The manufacturing method of the assembly injection molded article according to claim 1, wherein in each of the insertion members, the first end of the insertion member is provided with a protruding portion, and the protruding portion is extended from a surface of the first end of the insertion member toward a direction away from the surface of the insertion member.

3. The manufacturing method of the assembly injection molded article according to claim 2, wherein a side of the protruding portion close to the first injection molded member has a bottom face, the bottom face forms a gap with the first surface of the first injection molded member such that the bottom face of the protruding portion is covered by the second injection molded member when the second injection molded member is formed.

4. The manufacturing method of the assembly injection molded article according to claim 1, wherein the second surface of the first injection molded member is an appearance surface, and when the assembly injection molded article is molded, the second surface is exposed to an outer surface of the assembly injection molded article.

5. The manufacturing method of the assembly injection molded article according to claim 4, wherein in each of the insertion members, the first end of the insertion member is provided with a protruding portion, and the protruding portion is extended from a surface of the first end of the insertion member toward a direction away from the surface of the insertion member.

6. The manufacturing method of the assembly injection molded article according to claim 5, wherein a side of the protruding portion close to the first injection molded member has a bottom face, the bottom face forms a gap with the first surface of the first injection molded member such that the bottom face of the protruding portion is covered by the second injection molded member when the second injection molded member is formed.

7. The manufacturing method of the assembly injection molded article according to claim 1, wherein a single sided gap between each of the insertion members on the first injection molded member and the corresponding insertion hole is arranged to be less than 0.03 mm, and a single sided gap between each of the insertion members and the corresponding in-mold insertion hole is arranged between 0.03 mm and 0.2 mm.

8. The manufacturing method of the assembly injection molded article according to claim 7, wherein the single sided gap between each of the insertion members on the first injection molded member and the corresponding insertion hole is arranged between 0.005 mm and 0.025 mm.

9. The manufacturing method of the assembly injection molded article according to claim 8, wherein in each of the insertion members, the first end of the insertion member is provided with a protruding portion, and the protruding portion is extended from a surface of the first end of the insertion member toward a direction away from the surface of the insertion member.

10. The manufacturing method of the assembly injection molded article according to claim 9, wherein a side of the protruding portion close to the first injection molded member has a bottom face, the bottom face forms a gap with the first surface of the first injection molded member such that the bottom face of the protruding portion is covered by the second injection molded member when the second injection molded member is formed.

11. An assembly injection molded article, comprising:
a first injection molded member having a first surface and a second surface opposite to the first surface, and the first injection molded member being formed with a plurality of insertion holes respectively penetrating from the first surface to the second surface;
a plurality of insertion members; wherein two ends of each of the insertion members along a center axis direction are respectively defined as a first end and a second end, the insertion members are respectively inserted into the insertion holes, cross-sectional shapes of portions of the insertion members coupled to the insertion holes correspond to shapes of the insertion holes, the first ends of the insertion members are protruded from the first surface of the first injection molded member, and the second ends of the insertion members are protruded from the second surface of the first injection molded member; and
a second injection molded member formed on the first injection molded member, and the second injection molded member having a bottom face; wherein when the second injection molded member is formed, the bottom face of the second injection molded member is coupled to the first surface of the first injection molded member, and the first ends of the insertion members pass through the bottom face of the second injection molded member and are covered by the second injection molded member.

12. The assembly injection molded article according to claim 11, wherein the second surface of the first injection molded member is an appearance surface, and when the assembly injection molded article is molded, the second surface is exposed to an outer surface of the assembly injection molded article.

13. The assembly injection molded article according to claim 12, wherein in each of the insertion members, the first end of the insertion member is provided with a protruding portion, and the protruding portion is extended from a surface of the first end of the insertion member toward a direction away from the surface of the insertion member.

14. The assembly injection molded article according to claim 13, wherein a side of the protruding portion close to the first injection molded member has a bottom face, the bottom face forms a gap with the first surface of the first injection molded member such that the bottom face of the protruding portion is covered by the second injection molded member when the second injection molded member is formed.
